(19) United States
(12) Patent Application Publication
(10) Pub. No.: US 2021/0022148 A1
(43) Pub. Date: Jan. 21, 2021

(54) AN IMPROVED CHANNEL SELECTION METHOD FOR A WIRELESS LAN

(71) Applicant: British Telecommunications Public Limited Company, London (GB)

(72) Inventors: Simon RINGLAND, London (GB); Francis SCAHILL, London (GB)

(21) Appl. No.: 15/733,675

(22) PCT Filed: Mar. 25, 2019
(86) PCT No.: PCT/EP2019/057375

§ 371 Date: Sep. 28, 2020

(30) Foreign Application Priority Data
Mar. 29, 2018 (EP) 18165202.5

(51) Int. Cl. H04W 72/08; H04W 72/04; H04W 24/08

(52) U.S. Cl. CPC H04W 72/085; H04W 84/12; H04W 24/08; H04W 72/0446

(57) ABSTRACT

Disclosed is a method of selecting a channel for wireless communication between an access point and a client device in a WLAN, the method including obtaining a first performance measurement from a first channel during a first interval, obtaining a second performance measurement from a second channel during a second interval, the first interval being temporally separated from the second interval by a predetermined period which is greater than or equal to one second, and selecting a communication channel for use taking the first and second performance measurements into account.

### PRIORITY CLAIM

The present application is a National Phase entry of PCT Application No. PCT/EP2019/057375, filed Mar. 25, 2019, which claims priority from EP Patent Application No. 18165202.5, filed Mar. 29, 2018, each of which is hereby fully incorporated herein by reference.

### FIELD

This disclosure relates to the selection of a channel for use in wireless communication between an access point and a client device in a LAN.

### BACKGROUND

It is known that noise can negatively affect signals transmitted between an access point and a client device. Contention from neighboring access points can also negatively affect those signals. It is also known that the extent of the negative effect can depend on frequency. It is therefore desirable to choose a communication frequency (i.e. a communication channel) which performs best in terms of noise and contention. Known attempts to achieve this include performing a brief test of the performance of the available channels and selecting the best performing channel. It is desirable to provide an improved method of channel selection.

### SUMMARY

According to a first aspect of the disclosure there is defined a method of selecting a channel for wireless communication between an access point and a client device in a WLAN, the method comprising obtaining a first performance measurement from a first channel during a first interval, obtaining a second performance measurement from a second channel during a second interval, the first interval being temporally separated from the second interval by a predetermined period which is greater than or equal to one second, and selecting a communication channel for use taking the first and second performance measurements into account.

The inventors have realized that the noise and/or contention experienced by a channel can vary according to a pattern which cycles with a known period e.g. one week. The present disclosure enables a method to be performed which determines the best performing channel for each of the component segments of the period and uses that channel as the operating channel for that segment.

The first and second intervals may correspond to the same time slot in a repeating cycle. A “time slot” in this context is a segment of the repeating cycle. The duration of the repeating cycle may be the predetermined period. By the first and second intervals corresponding to the same time slot in a repeating cycle, it is meant that the first interval occurs during a first iteration of a cycle and the second interval occurs at the same point in a subsequent iteration of the cycle.

The start of the first interval may be temporally separated from the start of the second interval by the predetermined period. The end of the first interval may be temporally separated from the end of the second interval by the predetermined period. The predetermined period may be longer than the first and/or second intervals.

The method may further comprise making a plurality of first and/or second performance measurements during the first and/or second interval respectively. The plurality of first and/or second performance measurements may be made at a constant frequency during the first and/or second interval and may be made throughout the first and/or second interval. The frequency at which the first and/or second performance measurements are made may be greater than two per minute.

The first and/or second performance measurements may include one or more measurements of the noise on the channel. Noise on the channel may include interference from sources including but not limited to microwave ovens and analogue TV senders. The first and/or second performance measurements may include one or more measurements of the contention level on the channel. The contention level may be a measure of the amount of contending neighboring Wi-Fi traffic that is operating on the channel. The method may further include measuring the proportion of the first and/or second intervals for which data is sent from and/or received by the access point. Selecting a communication channel for use during the time slot the proportion of the first and/or second intervals for which data is sent from and/or received by the access point into account.

The duration of the first and/or second interval may be less than one day and may be between 30 minutes and two hours inclusive and in one embodiment is one hour.

The method may be performed at the access point. The duration of the predetermined period may be one hour and may be one day and is preferably seven days. Alternatively, the predetermined period may be one month or one year.

The method may further comprise obtaining a further first performance measurement from the first channel during a further first interval, obtaining a further second performance measurement from the second channel during a further second interval, the further first interval being temporally separated from the further second interval by the predetermined period, the first and second intervals corresponding to the same time slot in a repeating cycle, the duration of the cycle being the predetermined period, and selecting a communication channel for use during the time slot taking the further first and further second performance measurements into account. The further first and further second intervals may correspond to a different time slot in the repeating cycle than the first and second interval do.

There may be a plurality for further first intervals and a corresponding plurality of further second intervals. The plurality of further first intervals may run contiguously and may run for the full duration of the predetermined period. The plurality of further second intervals may run contiguously and may run for the full duration of the predetermined period.

The method may be performed upon subsequent channels. In such embodiments the method further comprises obtaining a subsequent performance measurement from a subsequent channel during a subsequent interval, the subsequent interval being temporally separated from the second interval by a multiple of the predetermined period, the second and subsequent intervals corresponding to the same time slot in a repeating cycle, the duration of the cycle being the predetermined period, and selecting a communication channel for use during the time slot taking the first, second and subsequent performance measurements into account. The first, second and subsequent intervals may all correspond to the same time slot in the repeating cycle.

The method may further comprise transmitting data between the access point and the client during some or all of the first and/or second and/or subsequent intervals.

The method may further comprise recording the performance measurements. The performance measurements may be recorded in a data store. The performance measurements may be averaged before being recorded. The performance measurements may be averaged over a sub interval of the first interval. The sub interval may have a duration of one minute.

Selecting a communication channel for use during a time slot may comprise determining a ranking score for each channel in respect of the time slot. The ranking score may depend on the performance of the channel. The selecting may comprise selecting the channel with best ranking score. The best ranking score may be the highest ranking score. Determining a ranking score may be done by an algorithm which may be a dynamic programming algorithm.

The lower the value of the one or more performance measurements made on a channel in a given interval, the higher the ranking score for the channel may be in respect of the corresponding time slot. The smaller the number of performance measurements made on a given channel in a given interval the larger the ranking score for that channel in respect of the corresponding time slot may be. The more recently a performance measurement on a given channel during a given interval was made, the lower the ranking score. The ranking may be recorded.

The method may include determining a performance score which may depend on the one or more performance measurements and may depend on the proportion of the first and/or second intervals for which data is sent from and/or received by the access point. The smaller the proportion of the first and/or second intervals for which data is sent from and/or received by the access point, the lower the performance score may be.

The ranking score for a given channel may depend on the channel that is the working channel immediately before the time slot begins. If the working channel immediately before the time slot begins is different to the given channel, a reduction may be applied to the ranking score of the given channel. The size of the reduction may depend on the length of time the working channel has been the working channel. The longer the working channel has been the working channel, the smaller the reduction may be. The amount of data traffic on the working channel at the start of a time slot may cause a reduction to be applied to the ranking score. The larger the amount of data traffic on the working channel at the start of the time slot, the larger the reduction that may be applied to the ranking score is. The ranking score may take into account the amount of data traffic that is known from prior measurements to flow between the access point and the client at the start of a given timeslot. In particular, the larger the amount of data traffic that is known from prior measurements to flow between the access point and the client at the start of a given timeslot, the lower the ranking score of channels that are not the current working channel.

The method may further comprise, for some or preferably all of a given time slot, using the highest-ranked channel as the working channel of the access point, i.e. using the highest-ranked channel as the channel upon which data is transmitted from and/or received by the access point. If, during a time slot, the performance score of the working channel falls below a usability threshold, the highest-ranked channel may be replaced as the working channel by the next highest-ranked channel.

According to a second aspect of the disclosure there is defined an access point adapted for communication with a client device in a LAN, the access point comprising a data collector adapted to collect a first performance measurement from a first channel during a first interval, the data collector being further adapted to collect a second performance measurement from a second channel during a second interval, the first interval being temporally separated from the second interval by a predetermined period which is greater than or equal to one second, the first and second intervals corresponding to the same time slot in a repeating cycle, the duration of the cycle being the predetermined period and a channel selector adapted to select a communication channel for use during the time slot taking the first and second performance measurements into account.

The access point is further adapted to carry out the method defined in accordance with the first aspect of the disclosure.

According to a third aspect of the disclosure there is defined a method of selecting a channel for communication between an access point and a client device in a WLAN, the method comprising: obtaining first and third performance measurements from a first channel, obtaining second and fourth performance measurements from a second channel, determining a first working channel taking the first and second performance measurements into account, determining a second working channel taking the third and fourth performance measurements into account, and, subsequently to the preceding, using the determined first working channel as the working channel of the access point and using the determined second working channel as the working channel of the access point.

The first performance measurement may be obtained from the first channel during a first interval. The second performance measurement may be obtained from the second channel during the second interval. The first interval may be temporally separated from the second interval by a predetermined period which is greater than or equal to one second. The first and second intervals corresponding to the same time slot in a repeating cycle. The duration of the repeating cycle may be the predetermined period.

The features defined in relation to the first and second aspects of the disclosure also apply to the third aspect of the disclosure.

### BRIEF DESCRIPTION OF FIGURES

A example embodiment of the disclosure will now be described, for illustration only, with reference to the appended drawings, in which

FIG. 1 is a schematic representation of a wireless LAN for use in accordance with embodiments of the disclosure.

FIG. 2 is a schematic representation of an initial channel plan in accordance with embodiments of the disclosure.

FIG. 3 is a schematic representation of a chart showing averaged values of the noise and contention levels.

FIG. 4 is a schematic representation of a performance and quality score chart in accordance with embodiments of the disclosure.

FIG. 5 is a schematic representation of an updated channel plan in accordance with the disclosure.

### DETAILED DESCRIPTION

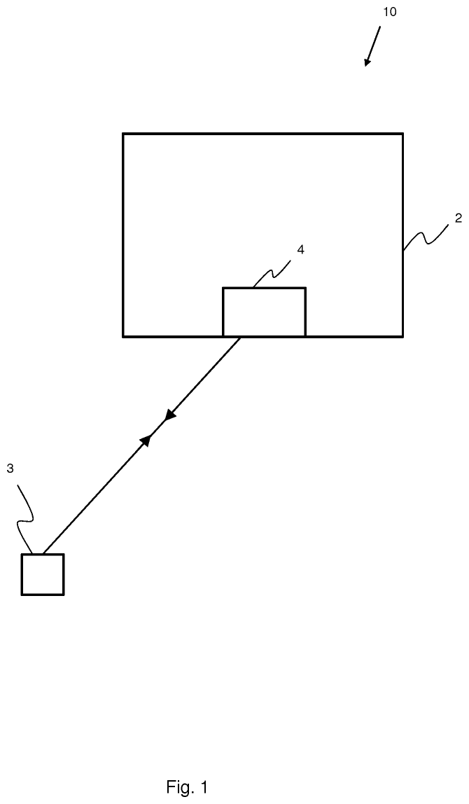

FIG. 1 shows a wireless LAN which is indicated generally at 10. The LAN 10 contains an access point 2 and a client device 3. The access point 2 contains a single radio 4 for communicating with the client 3. The radio 4 is capable of operating on several different frequencies within the frequency band of operation of the access point 2. In the present embodiment the band of operation is 2.4 GHz.

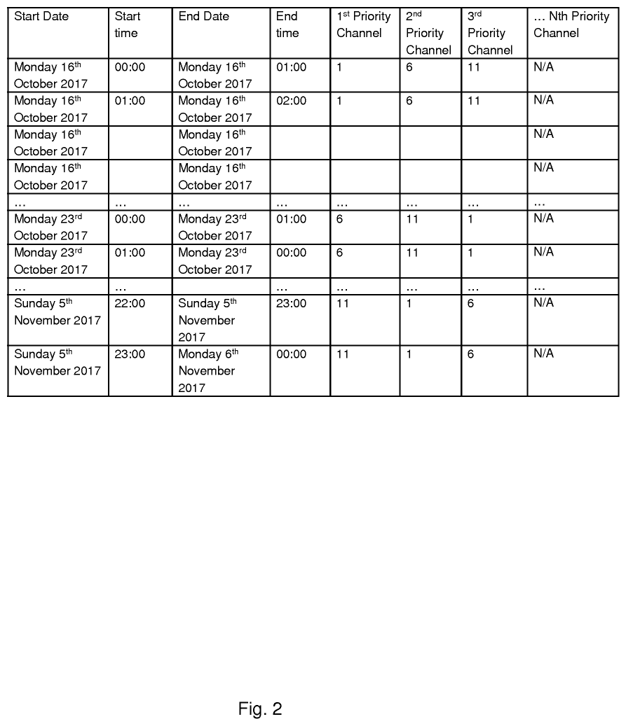

The access point 2 sends data to and receives data from the client 3 using a particular channel for a period of one week. At the end of the week, the access point 2 switches to a new channel and continues sending data to and receiving data from the client 3 using the new channel, also for a week. This process repeats, with the access point switching to a new channel of operation each week in accordance with a channel plan. The channel plan may change over time and is shown in its initial form in FIG. 2.

As can be seen, in the presently described embodiment there are three possible channels upon which the access point 2 can send and receive data. These channels are indicated in the channel plan shown at FIG. 2 as 1, 6 and 11. Each row of the channel plan relates to an hour-long time period on a specified date. The first row of the channel plan indicates that the 1^{st} priority channel is channel 1. This means that channel 1 is the working channel of the access point 2 during the indicated time period (i.e. 00:00 to 01:00 on Monday 16 Oct. 2017). As can be inferred from FIG. 2, channel 1 remains the working channel for the following week (i.e. until 00:00 on Monday 23 Oct. 2017), at which point the working channel switches to channel 6. Similarly, channel 6 remains the working channel until 00:00 on Monday 30 Oct. 2017 at which point the working channel switches to channel 11.

The next step is to produce an optimized version of the channel plan of FIG. 2. This is achieved as follows. For the time that a channel is the working channel, a noise level collector measures the noise level on that channel and a contention level collector measures the contention level on that channel. By noise level it is meant the amount of interference (e.g. from microwave ovens, analogue TV senders, etc.) experienced by the working channel. By contention level it is meant the proportion of the time that devices other than the access point and its associated clients are putting sufficient energy onto the channel that the channel appears busy and transmission between the access point and the clients is not possible. Furthermore, for the time that a channel is the working channel, the amount of time that data is being transmitted from or received by the access point is measured. This will be referred to as the “own utilization” measurement.

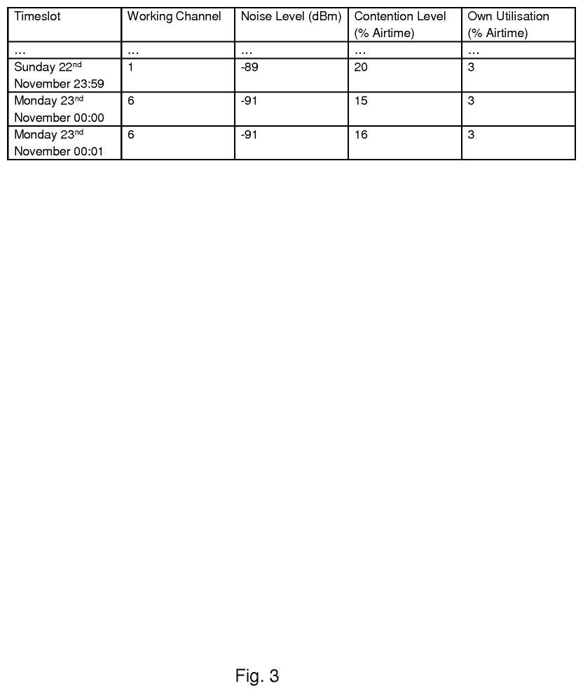

The noise level collector measures the noise level on the working channel multiple times each minute and then calculates the average noise level for that minute. That calculated average noise level is then recorded in a readings table (such as that shown at FIG. 3). Therefore, 60 new entries for the noise level are made to the readings table each hour. For example, the first line of the readings table of FIG. 3, the average noise level for the minute-long time slot between 23:59 on Sunday 22^{nd} November and 00:00 on Monday 23^{rd} November was calculated to be −89 dBm.

Similarly the contention level collector measures the contention level on the working channel multiple times each minute and then calculates the average contention level for that minute. That calculated average contention level is then recorded in a measurements table (such as that shown at FIG. 3). Therefore, 60 new entries for the contention level are made to the readings table each hour. For example, the first line of the measurements table of FIG. 3, the average contention level for the minute-long time slot between 23:59 on Sunday 22nd November and 00:00 on Monday 23rd November was calculated to be 20% airtime.

Similarly, the “own utilization” level, i.e. the proportion of each minute that the access point is sending or receiving data is measured and recorded. For example, the first line of the measurements table of FIG. 3, the own utilization level for the minute-long time slot between 23:59 on Sunday 22nd November and 00:00 on Monday 23rd November was 3% airtime.

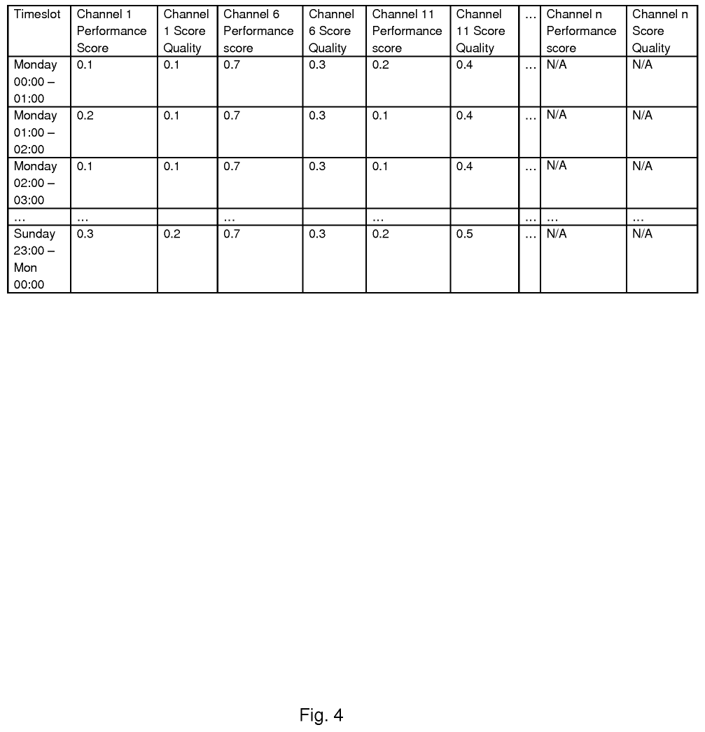

The averaged noise and contention levels from the measurements table are used to calculate a performance score for the working channel in respect of each hour. These calculated performance scores are entered in a performance table such as that shown in FIG. 4. The performance score is recalculated each time new noise and contention measurements are entered in the measurements table. Therefore a new value for the performance score is calculated every minute and entered into the performance table, replacing the previous performance score. The performance score is a function of the noise and contention levels. The higher the noise and contention levels, the higher the performance score.

If, at any point, the performance score rises above a usability threshold, this indicates that the noise and/or contention level on the channel is so high that the channel is effectively unusable. In such a situation, the working channel switches immediately to the next highest ranked channel in the channel plan of FIG. 2, which in this case is 2^{nd} ranked channel, channel 6. The method then proceeds as described above with channel 6 as the working channel.

The performance table also contains a column entitled “quality score”. Each performance score in the performance table has an associated quality score. The quality score is a measure of the quality of its associated performance score. A purpose of the quality score is to bias the system towards using as the working channel, channels for which fewer performance measurements have been made, or for which few performance measurements have recently been made. Therefore, the more measurements of the noise and contention level have been entered in the measurements table in respect of the hour in question, the higher the quality score. Moreover, the more recently any noise and contention measurements were made, the higher the quality score.

As mentioned above, channel 1 is the working channel for the first week of operation, channel 6 is the working channel for the second week of operation and channel 11 is the working channel for the third week of operation. During the second and third weeks, the process described above of obtaining and recording noise and contention levels and calculating performance and quality scores is performed for channel 6 and channel 11 in the same way it was for channel 1 in the first week.

If, at any point, the level of data traffic on the working channel is above an idle threshold, this indicates that there is significant data traffic on the channel. Changing channel at such a time would interrupt significant data flow and so is undesirable. Therefore, if at the time that the channel plan indicates that a channel change is due, the level of data traffic on the working channel is above the idle threshold, the channel change is delayed until the level of data traffic falls below the idle threshold.

The method includes ranking the channels in order of preference in respect of each hour-long time slot of the week. In other words, for each hour-long time slot of a generic week, each channel is given a ranking of either 1, 2 or 3. To do this, a ranking score is determined for each channel. The ranking scores are then compared in order to rank the channels in respect of each hour-long timeslot. The channel with the highest ranking score is ranked highest. The ranking score for a given channel is determined using the following factors relating to that channel:
1. The performance score. The higher the performance score, the higher the ranking score;
2. The quality score. The lower the quality score, the higher the ranking score;
3. Whether using the channel as the working channel would involve a channel change. If so, a reduction is made to the ranking score. This reduction will be referred to here as the “channel change penalty”;
4. If using the channel as the working channel would involve a channel change, the length of time since the previous channel change. The smaller the length of time since the previous channel change, the larger the channel change penalty.

If using the channel as the working channel would involve changing the working channel at a time when the level of data traffic on the working channel is above an idle threshold, the channel change penalty is increased. The recorded “own utilization” level is used to determine the level of data traffic.

The rankings are determined using a dynamic programming algorithm.

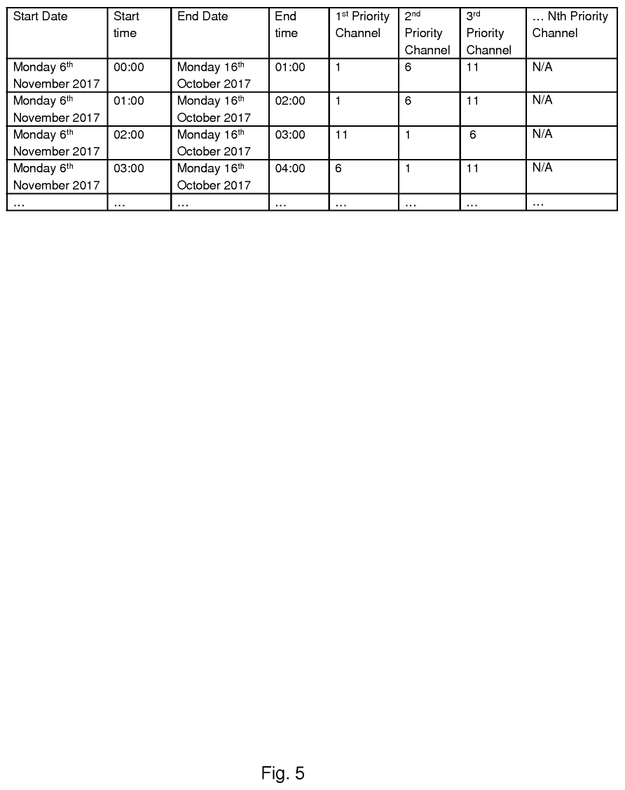

The rankings are used to update the initial channel plan of FIG. 2 to produce an updated channel plan. An example of such an updated channel plan is given at FIG. 5. As can be seen in FIG. 5, the updated channel plan shows a 1^{st} ranked, a 2^{nd} ranked and a 3^{rd} ranked channel in respect of each hour-long timeslot of the fourth week (week commencing Monday 6^{th} November 2017). The access point 2 then proceeds to operate (i.e. transmit data to and receive data from the clients in the LAN) using as the working channel for each time slot of the week, the channel identified in the updated channel plan. In particular, the access point uses the 1^{st} ranked channel associated with each timeslot in the channel plan as the working channel for that timeslot. The values shown in FIG. 5 are for illustrative purposes only and do not necessarily follow from the values shown in the preceding figures.

If the performance score associated with a particular channel is less than a usability threshold, this indicates that the noise and/or contention level on the channel is so high that the channel is effectively unusable. In such a case, the working channel switches to the 2^{nd} ranked channel for that timeslot for the remainder of the timeslot, and recalculates the future channel plan in the light of that change.

Furthermore, as previously, if at the time that the channel plan indicates that a channel change is due the level of data traffic on the working channel is above the idle threshold, the channel change is delayed until the level of data traffic falls below the idle threshold.

1. A method of selecting a channel for wireless communication between an access point and a client device in a WLAN, the method comprising:
obtaining a first performance measurement from a first channel during a first interval;
obtaining a second performance measurement from a second channel during a second interval, the first interval being temporally separated from the second interval by a predetermined period which is greater than or equal to one second; and
selecting a communication channel for use taking the first performance measurement and the second performance measurement into account.

2. The method as claimed in claim 1, further comprising making a plurality of first performance measurements during the first interval.

3. The method as claimed in claim 1, the method further comprising making a plurality of second performance measurements during the second interval.

4. The method as claimed in claim 1, wherein at least one of the first performance measurement or the second performance measurement includes one or more measurements of noise on the channel.

5. The method as claimed in claim 1, wherein at least one of the first measurement or the second performance measurement includes one or more measurements of a contention level on the channel.

6. The method as claimed in claim 1, wherein at least one of the first interval or the second interval has a duration of one hour.

7. The method as claimed in claim 1, wherein the predetermined period has a duration of seven days.

8. The method as claimed in claim 1, further comprising:
obtaining a further first performance measurement from the first channel during a further first interval;
obtaining a further second performance measurement from the second channel during a further second interval, the further first interval being temporally separated from the further second interval by the predetermined period, the first and second intervals corresponding to the same time slot in a repeating cycle, a duration of the cycle being the predetermined period; and
selecting a communication channel for use during the time slot taking the further first performance measurement and the further second performance measurement into account.

9. The method as claimed in claim 8, wherein the further first interval corresponds to a different time slot in the repeating cycle than the first interval.

10. The method as claimed in claim 8, wherein the further second interval corresponds to a different time slot in the repeating cycle to the second interval.

11. The method as claimed in claim 1, further comprising recording the first performance measurement and the second performance measurement.

12. The method as claimed in claim 11, wherein the first performance measurement and the second performance measurement are averaged before being recorded.

13. The method as claimed in claim 12, wherein the first performance measurement and the second performance measurement are averaged over a sub interval of the first interval, the sub interval having a duration of one minute.

14. An access point adapted for communication with a client device in a LAN, the access point comprising:
a data collector adapted to collect a first performance measurement from a first channel during a first interval, the data collector being further adapted to collect a second performance measurement from a second channel during a second interval, the first interval being temporally separated from the second interval by a predetermined period which is greater than or equal to one second, the first interval and the second interval corresponding to the same time slot in a repeating cycle, the duration of the repeating cycle being the predetermined period; and
a channel selector adapted to select a communication channel for use during the time slot taking the first performance measurement and the second performance measurement into account.

15. A method of selecting a channel for communication between an access point and a client device in a WLAN, the method comprising:
obtaining a first performance measurement and a second performance measurement from a first channel;
obtaining a third performance measurement and a fourth performance measurement from a second channel;
determining a first working channel taking the first performance measurement and the third performance measurement into account;
determining a second working channel taking the third performance measurement and the fourth performance measurement into account; and
subsequently using the determined first working channel as a working channel of the access point and using the determined second working channel as a working channel of the access point.
